(19) United States
(12) Patent Application Publication
(10) Pub. No.: US 2012/0301721 A1
(43) Pub. Date: Nov. 29, 2012

(54) Alpha-Alumina and Associated Use, Synthesis Method and Device

(75) Inventors: Lionel Bonneau, Cran Gevrier (FR); Michel Pezzani, Poisy (FR)

(73) Assignee: Balkowski, Poisy (FR)

(21) Appl. No.: 13/578,005

(22) PCT Filed: Feb. 10, 2011
(86) PCT No.: PCT/EP2011/051938

§ 371 Date: Aug. 9, 2012

(30) Foreign Application Priority Data
Feb. 11, 2010 (FR) FR1000594

(51) Int. Cl. C01F 7/02

(52) U.S. Cl. 428/402; 423/625; 422/243

(57) ABSTRACT

The invention relates to alpha-alumina with a purity of greater than or equal to 99.99%, in the form of spherical particles (1) with a size predominantly greater than or equal to 850 μm.

The invention also relates to the use of alpha-alumina as defined above, and to a related process for synthesizing and device.

The invention relates to alpha-alumina, which is suitable in particular for use in the manufacture of single-crystal sapphire. The invention also relates to a related process for synthesizing this alpha-alumina and to a related device.

In a known manner, besides the Verneuil process, alpha-alumina is used for the manufacture of single-crystal sapphire. To this end, alpha-alumina powder may be placed in a crucible, which is heated to a melting point of between, for example, 1900° C. and 2400° C. for a predefined period. Next, for a predefined period, a tip bearing a crystal (or seed) is placed in contact with the molten alpha-alumina so that the crystal grows under control of the thermal gradients.

Alpha-alumina intended far use as raw material hr the manufacture of single-crystal sapphire, with a particle size distribution having a maximum for a particle size of between 100 nm and less than 850 μm, is known.

In order to optimize the process for manufacturing single-crystal sapphire, it would be necessary to increase the density of alpha-alumina in the crucible relative to the density obtained with this known solution.

However, the processes for synthesizing used starting with alpha-alumina do not make it possible to increase the density of alpha-alumina while at the same time having the characteristics necessary for the production of a single-crystal sapphire.

The object of the present invention is thus to overcome these drawbacks of the prior art.

To this end, one subject of the invention is alpha-alumina with a purity of greater than or equal to 99.99%, in the form of spherical particles with a size predominantly greater than or equal to 850 μm.

The alpha-alumina may thus be loaded into the crucible to a high density; without generation of fine particles and without oxidation of the crucible during the melting.

The alpha-alumina according to the invention may also comprise one or more of the following characteristics, taken separately or in combination:
the size of said spherical particles is predominantly between 850 μm and 2 mm,
said particles have a sphericity ratio of between 1 and 2,
said spherical particles have a specific surface area of less than or equal to 1 m²/g,
said spherical particles have a relative density greater than or equal to 50% of the theoretical density of 3.96 g/cc.

The invention also relates to the use of alpha-alumina as defined previously for the manufacture of single-crystal sapphire.

The invention also relates to a process for synthesizing alpha-alumina as defined previously, characterized in that it comprises the following steps:
gamma-alumina powder is placed on a silicon carbide plate, and
said powder is subjected to at least one CO₂ laser beam.

Said process may also comprise one or more of the following characteristics, taken separately or in combination:
the gamma-alumina powder has a purity of greater than or equal to 99.99%,
the gamma-alumina powder has a specific surface area of between 90 m²/g and 120 m²/g,
the gamma-alumina powder comprises elemental particles with a size of between 15 nm and 20 nm, generating a pore volume of 3.5 ml/g to 4 ml/g and having a tamped density of between 0.12 g/cc and 0.25 g/cc,
the gamma-alumina powder is arranged in the form of a coat of powder with a thickness of between 1 mm and 8 mm,
the gamma-alumina powder is moved under said at least one beam,
the speed of movement of the gamma-alumina powder under said at least one beam is between 10 cm/minute and 100 cm/minute,
the gamma-alumina powder is subjected to said at least one beam over a time period of between 0.3 second and 30 seconds,
said process for synthesizing includes a screening step.

The invention also relates to a device for performing the process for synthesizing as defined above, characterized in that it comprises:
a means for feeding in gamma-alumina powder,
a silicon carbide plate on which said powder is placed, and
at least one CO₂ laser.

Said device may also comprise one or more of the following characteristics, taken separately or in combination:
said at least one laser is fixed and said plate is mobile so as to continuously convey the gamma-alumina powder under said at least one beam,
said mobile plate is made in the form of a rotating disc,
said plate comprises a hollow groove to receive the gamma-alumina powder, the wavelength of said at least one laser is about 10.6 μm,
the power of said at least one laser is between 120 W and 3000 W,
said at least one laser is configured so that the size of the light spot of said at least one beam on a zone impacted by said at least one beam covers an area of between 0.2 and 20 cm²,
said device comprises a means for uniformly dispensing the gamma-alumina powder placed on said plate,
said uniform dispensing means comprises a compression roller,
said uniform dispensing means comprises a levelling means,
said device comprises a means for evacuating by suction the spherical alpha-alumina particles synthesized.

Other characteristics and advantages of the invention will emerge more clearly on reading the following description, which is given as a non-limiting illustrative example, and the attached drawings, among which:

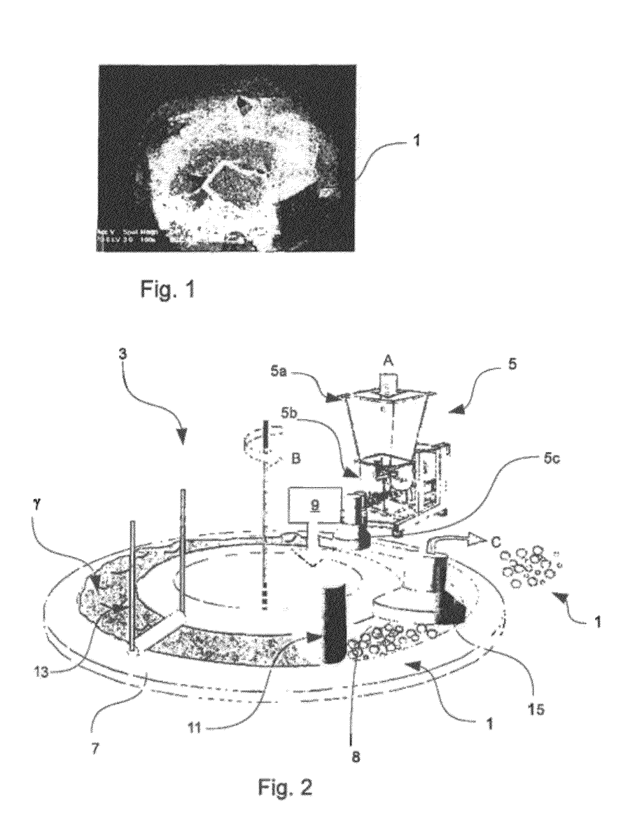

FIG. 1 is a view by electron microscope of a spherical alpha-alumina particle according to the invention, and

FIG. 2 is a schematic representation of a device for performing a process for synthesizing alpha-alumina according to the invention.

### ALPHA-ALUMINA

The invention relates to alpha-alumina of high purity, more specifically of greater than or equal to 99.99%, in the form of spherical particles to be used in particular as raw materials in the manufacture of single-crystal sapphire. The evaluation of the sphericity of these alpha-alumina particles may be performed by calculating the ratio of the maximum diameter measurement to the minimum diameter measurement according to the relationship (1).

(1) S=dₘₐₓ/dₘᵢₙ (in which S=sphericity ratio, dₘₐₓ=maximum diameter, and dₘᵢₙ=minimum diameter)

The Applicant has found that the alpha-alumina particles according to the invention have a sphericity ratio S of between 1 and 2.

FIG. 1 shows a spherical alpha-alumina particle 1 viewed using an electron microscope. The scale is indicated on this figure.

The spherical alpha-alumina particles 1 synthesized according to the invention are large.

Specifically, the granulometric weight distribution of synthesized alpha-alumina according to the invention shows a majority of spherical particles 1 with a size greater than or equal to 850 μm, more specifically between 850 μm and 2 mm. The granulometric distribution is obtained, for example, by dry screening according to a screen stacking method described hereinbelow.

Moreover, these spherical alpha-alumina particles 1 have a specific surface area of less than or equal to 1 m²/g. In a known manner, this specific surface area may be measured by the BET method using liquid nitrogen.

These spherical alpha-alumina particles 1 also have a relative density of greater than 50% relative to the theoretical density of 196 g/cc.

Thus, these spherical alpha-alumina particles 1 may be charged at high density in a crucible without generating fine particles and without oxidation of the crucible during melting.

A screen stacking method that can produce the granulometric distribution is described below.

A stack of screens with different mesh apertures is organized, with the screen of largest mesh aperture at the top of the stack, for example a mesh aperture of 1600 μm, and the screen with the smallest mesh aperture at the bottom of the stack, for example a mesh aperture of 90 μm.

By way of example, different screens having the following mesh apertures are used: 1600μ, 1400μ, 1000μ, 850μ, 710μ, 500μ, 355μ, 250μ, 180μ, 125μ and 90μ.

A sample of spherical alpha-alumina particles 1, for example of a predefined weight such as 200 g plus or minus 10 g, is placed on the top screen with the largest mesh aperture.

The stack of screens is then shaken for a given time, for example 10 minutes, by means of suitable mechanical equipment.

The particles retained on each screen are then extracted, weighed and recorded.

It is considered that a particle retained on a screen has a size between the mesh aperture size of the screen on which it is retained and the mesh aperture size of the upper screen. In other words, for a particle passing through the screen with a mesh aperture, for example, of 850 μm and retained on the lower screen with a mesh aperture, for example, of 710 μm, it is considered that the size of this particle is between 710 μm and 850 μm.

The rate of spherical particles on each screen is then calculated by dividing the mass of the spherical particles retained on the screen under consideration by the initial mass of the sample.

With reference now to FIG. 2, a device 3 for performing a process for synthesizing such spherical alpha-alumina particles 1 is described.

Device for Performing a Process for Synthesizing Alpha-Alumina

Device 3 comprises:
a means 5 for feeding in gamma-alumina powder γ,
a silicon carbide (SiC) plate 7 comprising a hollow groove 8 in which the gamma-alumina powder γ is placed, and
at least one CO₂ laser 9, represented diagrammatically, emitting a beam of laser radiation 11.

The feed means 5 comprises, for example, a receiving tank 5a for receiving the gamma-alumina powder γ, as illustrated schematically by arrow A, an endless screw 5b and a dispenser 5c of gamma-alumina powder γ on the plate 7.

In order to obtain the best characteristics for the spherical alpha-alumina particles 1, the gamma-alumina powder γ chosen as raw material for the synthesis of the spherical alpha-alumina particles 1 according to the invention has the following characteristics: a purity of greater than or equal to 99.99%, a specific surface area of between 90 m²/g and 120 m²/g, elemental particles with a size of between 15 nm and 20 nm, generating a pore volume of 3.5 ml/g to 4 ml/g and having a tamped density of between 0.12 g/cc and 0.25 g/cc.

This means that the gamma particles are associated as agglomerates. These agglomerates are porous. The pore volume of these agglomerates is 3.5 ml/g to 4 ml/g.

Such a gamma-alumina powder is sold, for example, by Baikowski under the name Baikalox B 105.

In the illustrated example, the plate 7 is a mobile rotating disk in rotation about a rotational axis as illustrated diagrammatically in arrow B. By way of example, the plate 7 rotates at a speed of between 10 cm/minute and 100 cm/minute in the groove 8. The plate 7 thus gradually conveys the gamma-alumina powder γ towards the zone impacted by the laser beam 11 of the laser 9.

The laser 9 is, according to the described embodiment, a laser with a wavelength of 10.6 μm, a power of between 120 W and 3000 W and a substantially circular laser spot covering an area of between 0.2 and 20 cm².

The device 3 may also comprise a means 13 for uniformly dispensing the gamma-alumina powder γ placed on the plate 7, such as a compression roller or a tamping roller. The uniform dispensing means 13 may comprise, additionally or as a variant, a levelling means for levelling the gamma-alumina coat γ.

Finally, the device 3 comprises, for example, a means 15 for evacuating by suction the synthesized spherical alpha-alumina particles 1.

The various steps of a process for the synthesis of these spherical alpha-alumina particles 1 are now described.

### Process for Synthesizing

As illustrated by arrow A, during a preliminary step, gamma-alumina powder γ is placed, for example, in the receiving tank 5a, which arrives at the dispenser 5c and is dispensed onto the rotating plate 7, for example in the form of a coat with a thickness of between 1 mm and 8 mm.

This gamma-alumina powder γ may be compacted and/or levelled off for example by means of a uniform dispensing device 13 so as to enable optimum synthesis when the gamma-alumina powder γ is impacted by the laser beam 11.

As a result of the movement of the plate 7, the gamma-alumina powder γ gradually moves under the laser beam 11, for example at a speed of between 10 cm/minute and 100 cm/minute, and is subjected to the laser beam 11 over a period of between 0.3 second and 30 seconds.

The gamma-alumina powder γ thus treated is converted into an assembly of spherical alpha-alumina particles 1 as defined previously.

These spherical alpha-alumina particles 1 may then be sucked, for example via the evacuation means 15, so as to be evacuated from the plate 7 as illustrated schematically by arrow C.

Screening of these spherical particles may be performed as described previously.

The spherical alpha-alumina particles 1 thus synthesized may then serve as raw materials for the manufacture of single-crystal sapphire.

In order to illustrate more specifically such a process for synthesizing spherical alpha-alumina particles 1 and the characteristics of the spherical alpha-alumina particles 1 obtained, three embodiments are now detailed.

In these examples, gamma-alumina powder γ with a purity of greater than or equal to 99.99%, with a specific surface area of between 90 m²/g and 120 m²/g, and comprising elemental particles with a size of between 15 mm and 20 mm, generating a pore volume of 3.5 ml/g to 4 ml/g and having a tamped density of between 0.12 g/cc and 0.25 g/cc, is used as raw material.

### FIRST EXAMPLE

For this first example, a rotating plate 7 made of silicon carbide (SIC) and a carbon dioxide (CO₂) laser 9 with a wavelength of 10.6 μm and a power of 1500 W, with a laser spot over an area of 25 mm², are used as materials.

A coat of gamma-alumina powder γ 4 mm thick is gradually deposited in the groove 8 of the rotating plate 7.

As stated previously, the gamma-alumina powder γ is subjected to the laser beam and passes under the laser spot at a speed of 10 mm/second.

Alumina of alpha crystallographic structure is then obtained, in the form of spherical particles 1 with a density of 2.12 g/cc developing a specific surface area of 0.16 m²/g and whose granulometric distribution, measured by the screen stacking method as explained previously, is as follows:

for a mesh aperture of 1600 μm, the weight percentage is 0%
for a mesh aperture of 1400 μm, the weight percentage is 13.1%
for a mesh aperture of 1000 μm, the weight percentage is 47.6%
for a mesh aperture of 850 μm, the weight percentage is 14.2%
for a mesh aperture of 710 μm, the weight percentage is 9.3%
for a mesh aperture of 500 μm, the weight percentage is 7.3%
for a mesh aperture of 355 μm, the weight percentage is 3.2%
for a mesh aperture of 250 μm, the weight percentage is 1.6%
for a mesh aperture of 180 μm, the weight percentage is 1.1%
for a mesh aperture of 125 μm, the weight percentage is 0.9%
for a mesh aperture of 90 μm, the weight percentage is 0.6%
for a mesh aperture of less than 90 μm, the weight percentage is 1.1%.

In light of these results, it is obvious that the granulometric distribution has a maximum for a size of greater than 850 μm. Specifically, 74.9% of the spherical alpha-alumina particles 1 have a size greater than 850 μm.

### SECOND EXAMPLE

For this second example, a rotating plate 7 made of silicon carbide (SiC) and a carbon dioxide (CO₂) laser 9 with a wavelength of 10.6 para and a power of 1500 W, with a laser spot over an area of 25 mm², are used as materials.

A coat of gamma-alumina powder γ 6 mm thick is gradually deposited in the groove 8 of the rotating plate 7. The gamma-alumina powder γ is subjected to the laser beam and passes under the laser spot at a speed of 7.6 mm/second.

Alumina of alpha crystallographic structure is then obtained, in the form of spherical particles 1 with a density of 2.12 g/cc developing a specific surface area of 0.12 m²/g and whose granulometric distribution, measured by the screen stacking method as explained previously, is as follows:
for a mesh aperture of 1600 μm, the weight percentage is 0%
for a mesh aperture of 1400 μm, the weight percentage is 35.7%
for a mesh aperture of 1000 μm, the weight percentage is 28.9%
for a mesh aperture of 850 μm, the weight percentage is 6.7%
for a mesh aperture of 710 μm, the weight percentage is 5.8%
for a mesh aperture of 500 μm, the weight percentage is 7.9%
for a mesh aperture of 355 μm, the weight percentage is 5.2%
for a mesh aperture of 250 μm, the weight percentage is 3.6%
for a mesh aperture of 180 μm, the weight percentage is 2.4%
for a mesh aperture of 125 μm, the weight percentage is 2%
for a mesh aperture of 90 μm, the weight percentage is 1.3%
for a mesh aperture of less than 90 μm, the weight percentage is 0.5%.

These results also show that the granulometric distribution has a maximum for a size greater than 850 μm. Specifically, 71.3% of the spherical alpha-alumina particles 1 have a size greater than 850 μm.

For this third example, a rotating plate 7 made of silicon carbide (SiC) is again used as material, but with a carbon dioxide (CO₂) laser 9 with a wavelength of 10.6 μm and a power of 3000 W with a laser spot over an area of 44 mm².

A coat of gamma-alumina powder γ 6 mm thick is gradually deposited in the groove 8 of the rotating plate 7. The gamma-alumina powder γ is subjected to the laser beam and passes under the laser spot at a speed of 11.3 mm/second.

Alumina of alpha crystallographic structure is then obtained, in the form of spherical particles 1 with a density of 2.42 g/cc developing a specific surface area of 0.15 m²/g and whose granulometric distribution, measured by the screen stacking method as explained previously, is as follows:
for a mesh aperture of 1600 μm, the weight percentage is 0%
for a mesh aperture of 1400 am, the weight percentage is 28.3%
for a mesh aperture of 1000 μm, the weight percentage is 26.3%
for a mesh aperture of 850 μm, the weight percentage is 8%
for a mesh aperture of 710 μm, the weight percentage is 7.6%
for a mesh aperture of 500 μm, the weight percentage is 8.9%
for a mesh aperture of 355 μm, the weight percentage is 5.7%
for a mesh aperture of 250 μm, the weight percentage is 4.5%
for a mesh aperture of 180 μm, the weight percentage is 2.9%
for a mesh aperture of 125 μm, the weight percentage is 2.3%
for a mesh aperture of 90 μm, the weight percentage is 2.3%
for a mesh aperture of less than 90 μm, the weight percentage is 3.5%.

The granulometric distribution of the spherical alpha-alumina particles 1 obtained according to this third example also shows a maximum for a size greater than 850 μm. Specifically, 62.6% of the spherical alpha-alumina particles 1 have a size greater than 850 μm.

In these examples, the gamma-alumina powder γ is subjected to the CO₂ laser beam 11 with a wavelength of 10.6 μm and a power of between 120 W and 3000 W over a time period of between 0.3 second and 30 seconds.

Specifically, these characteristics of wavelength, power and time of passage of the gamma-alumina γ under the beam are appropriate for the gamma-alumina as described previously, i.e. a gamma-alumina powder γ with a purity of greater than or equal to 99.99%, a specific surface area of between 90 m²/g and 120 m²/g, elemental particles with a size of between 15 μm and 20 μm associated as porous agglomerates whose pore volume is from 15 ml/g to 4 ml/g, and with a tamped density of between 0.12 g/cc and 0.25 g/cc.

Such a gamma-alumina powder is sold, for example, by Baikowski under the name Baikalox B 105.

Needless to say, for gamma-alumina having other characteristics, the same wavelength, laser beam power and passage time parameters may be envisaged. These parameters may also be adapted to obtain better characteristics for the spherical alpha-alumina particles α.

It is thus understood that the spherical alpha-alumina particles 1 according to the invention, obtained according to a particular process for synthesizing as described above, have purity and density characteristics that are suited to the manufacture of single-crystal sapphire, while at the same time making it possible to optimize the process for manufacturing single-crystal sapphire for which they serve as raw materials.

1. Alpha-alumina with a purity of greater than or equal to 99.99%, in the form of spherical particles with a size predominantly greater than or equal to 850 μm.

2. Alpha-alumina according to claim 1, characterized in that the size of the spherical particles is predominantly between 850 μm and 2 mm.

3. Alpha alumina according to claim 1 characterized in that said particles have a sphericity ratio of between 1 and 2.

4. Alpha-alumina according to claim 1 characterized in that said spherical particles have a specific surface area of less than or equal to 1 m²/g.

5. Alpha-alumina according to claim 1 characterized in that said spherical particles have a relative density greater than or equal to 60% of the theoretical density.

6. Use of alpha-alumina according to claim 1 for the manufacture of single-crystal sapphire.

7. A process for synthesizing alpha-alumina having a purity greater than or equal to 99.99% in the form of spherical particles with a size predominantly greater than or equal to 850 μm, the process comprising:
placing gamma-alumina powder (γ) on a silicon carbide plate; and
subjecting said gamma-alumina powder (γ) to at least one CO2 laser beam.

8. The process for synthesizing according to claim 7, characterized in that the gamma-alumina powder (γ) has a purity of greater than or equal to 99.99%.

9. The process for synthesizing according to claim 7 characterized in that the gamma-alumina powder (γ) has a specific surface area of between 90 m2/g and 120 m²/g.

10. The process for synthesizing according to claim 7 characterized in that the gamma-alumina powder (γ) comprises elemental particles with a size of between 16 nm and 20 nm, generating a pore volume of 3.5 ml/g to 4 ml/g and having a tamped density of between 0.12 g/cc and 0.25 g/cc.

11. The process for synthesizing according to claim 7 characterized in that the gamma-alumina powder (γ) is in the form of a coat of powder with a thickness of between 1 mm and 8 mm.

12. The process for synthesizing according to claim 7 characterized in that the gamma-alumina powder (γ) is moved under said at least one beam.

13. The process for synthesizing according to claim 12, characterized in that the speed of movement of the gamma-alumina powder (γ) under said at least one beam is between 10 cm/minute and 100 cm/minute.

14. The process for synthesizing according to claim 7 characterized in that the gamma-alumina powder (γ) is subjected to said at least one beam over a time period of between 0.3 second and 30 seconds.

15. The process for synthesizing according to claim 7 characterized in that it comprises a screening step.

16. A device for performing a process for synthesizing alpha-alumina having a purity greater than or equal to 99.99% in the form of spherical particles with a size predominantly greater than or equal to 850 μm, the device comprising:
a means for feeding in gamma-alumina powder (γ),
a silicon carbide plate on which said powder (γ) is placed, and
at least one CO2 laser.

17. The device according to claim 16, characterized in that said at least one laser is fixed and in that said plate is mobile so as to continuously convey the gamma-alumina powder (γ) under said at least one beam.

18. The device according to claim 17, characterized in that said mobile plate is made in the form of a rotating disc.

19. The device according to claim 16 characterized in that said plate comprises a groove for receiving the gamma-alumina powder (γ).

20. The device according to claim 16 characterized in that the wavelength of said at least one laser is 10.6 μm.

21. The device according to claim 16 characterized in that the power of said at least one laser is between 120 W and 3000 W.

22. The device according to claim 16 characterized in that said at least one laser is configured so that the size of the light spot of said at least one beam on a zone impacted by said at least one beam covers an area of between 0.2 and 20 cm².

23. The device according to claim 16 characterized in that it comprises a means for uniformly dispensing the gamma-alumina powder (γ) placed on said plate.

24. The device according to claim 23, characterized in that said uniform dispensing means comprises a compression roller.

25. The device according to claim 23 characterized in that said uniform dispensing means comprises a levelling means.

26. The device according to claim 16 characterized in that it comprises means for evacuating by suction synthesized spherical alpha-alumina particles.
